(19) United States
(12) Patent Application Publication
(10) Pub. No.: US 2012/0024679 A1
(43) Pub. Date: Feb. 2, 2012

(54) SWITCHING DEVICE WITH A GEOMETRIC ELEMENT FOR IMPACT OF THE MOVEMENT OF THE MOVABLE CONTACT ELEMENT

(75) Inventors: Karsten Gerving, Bonn (DE); Norbert Roesner, St. Augustin (DE)

(73) Assignee: EATON INDUSTRIES GMBH, Bonn (DE)

(21) Appl. No.: 13/195,137

(22) Filed: Aug. 1, 2011

(30) Foreign Application Priority Data
Aug. 2, 2010 (EP) 10 171 619.9

(51) Int. Cl. H01H 1/20

(52) U.S. Cl. 200/243

(57) ABSTRACT

A switching device includes a housing and an actuator disposed in the housing. The actuator includes a fixed contact element and a movable contact element, the movable contact element being a bridge forming contact in a bridge contact working area and being movable between a closed ON position and an open OFF position. A geometric component is disposed above the movable contact element with respect to an opening direction of the movable contact element and includes a geometric element configured to impact dynamics of a closing movement of the movable contact element.

### CROSS REFERENCE TO RELATED APPLICATIONS

This application claims priority to European Patent Application EP 10 17 1619.9, filed Aug. 2, 2010, which is hereby incorporated by reference herein in its entirety.

### FIELD

The invention relates to electrical switching devices, comprising an actuator in a housing, having a fixed and a movable contact element as a bridge forming contact in a bridge contact working area, wherein said bridge forming contact can be moved between a closed, i.e. ON, and a open, i.e. OFF, position. Such switching devices may be contactors, but may also be circuit breakers, motor protective switches or other switching devices for disconnecting currency.

### BACKGROUND

In case of conducting current the movable contact element is strive to lift from the fixed contact element due to the resulting electrodynamic forces. In case the moveable contact element lifts from the fixed contact element when current is flowing, an electric arc will occur in dependence to the current flowing. Such electric arcs may cause melting of the contact material and electrode erosion. In EP 0 323 404 B1 a tripping device is described, which contains so called contact force springs, which shall avoid such lifting. Such springs with high spring forces counteract the velocity of contact opening in case of a short-circuit or other operating conditions of the switching device, where an opening of the contacts is necessary. The electrodynamic forces depend on the distance between the contact elements, amongst others. If the movable contact element is lifted from the fixed contact element, the electrodynamic force will decrease, and the force of the contact force spring may be higher than said electrodynamic force. As a result the movable contact element will close again. This will be repeated until the tripping device, which is applied with mass inertia, will finally disconnect the circuit. If the movable contact element lifts and touches the fixed contact element again in due time, there exists the risk of welding between the fixed and the movable contact elements, depending on the current flowing, the duration of current flow and the contact materials. Even if the movable contact element won't alternate between these spots like described before, but comes in touch with the fixed contact element quite shortly after a quick disconnection of the circuit, it may weld with the fixed contact element. The result of such welding is that the device may not be able to disconnect the current. Damages for facilities and health may occur. In other cases specified tests for such switching devises are not passed.

DE 100 20 695 A1 describes a permanent magnetic restraint system for the movable contact element as a solution for this problem. The tripping device contains this permanent magnetic restraint system and a mechanical or again permanent magnetic acceleration system. The magnetic restraint system safeguards the contact between the movable and the fixed contact element at normal working conditions. In case of an abnormal high current the electrodynamic forces drive the contact elements apart. The acceleration system reinforces this effect. On the other hand, the force of the permanent magnetic restraint system decreases with the distance of the contact elements.

### SUMMARY

In an embodiment, the present invention provides a switching device including a housing and an actuator disposed in the housing. The actuator includes a fixed contact element and a movable contact element, the movable contact element being a bridge forming contact in a bridge contact working area and being movable between a closed ON position and an open OFF position. A geometric component is disposed above the movable contact element with respect to an opening direction of the movable contact element and includes a geometric element configured to impact dynamics of a closing movement of the movable contact element.

### BRIEF DESCRIPTION OF THE DRAWINGS

Exemplary embodiments of the present invention are described in more detail below with reference to the drawings, in which:

FIG. 1 shows a switching device with an actuator shown in a cutaway view;

FIG. 2 shows a bridge contact working area with a geometric element above the movable contact element having a first, long member and a second, short member;

FIG. 3 shows a bridge contact working area with a geometric element above the movable contact element having an element formed as tentacle; and

FIG. 4 shows a bridge contact working area with a geometric element above the movable contact element comprising a detent hook

### DETAILED DESCRIPTION

An embodiment of the present invention avoids the disadvantage of the necessity of such permanent magnetic restraint system and a mechanical or again permanent magnetic acceleration system, which cause big switch sizes and high costs.

In an embodiment, the present invention provides a switching device which reduces the risk of welded contact elements in case of short-circuits or other abnormal high currents without the above-described disadvantages. In an embodiment, the present invention provides a method for reducing the risk of welded contact elements in switching devices even in cases of short-circuits or other abnormal high currents without the necessity of big switch sizes and at lower costs than conventional switches.

In an embodiment, the present invention provides a switching device, comprising an actuator in a housing, having a fixed and a movable contact element as a bridge forming contact in a bridge contact working area, wherein said bridge contact can be moved between a closed, i.e. ON, and a open, i.e. OFF, position, and wherein the switching device has a geometric element, located above the moveable contact element in view of the opening direction having a geometric element with at least one member, which is able to impact the dynamics of the closing movement of the movable contact element.

An advantage of the switching device and of the relating method lies in the effective and reliable increase of the resistance for the closing movement of the moveable contact element.

An embodiment of the invention relates to a geometric element located above the moveable contact element in view of the opening direction having a geometric element with at least one member, which is able to impact the dynamics of the closing movement of the movable contact element by transferring the translational opening work of the movable contact element in rotation work. This rotation work is greater than the translational work to be done for the same dimension of opening distance of the movable contact.

Advantageously the movable contact will be deferred in its closing movement, as in case of re-closing of the contacts this rotation work has to be done again.

This embodiment allows the necessary force for breaking a possibly welding of the contacts to be less than in the other cases and may be achieved by the switching device. Possible electrode erosion and melting of the material of the moveable contact element which is caused by the electric arc is located at the side wall of the moveable contact element located in general perpendicular to the contact area instead of at the intrinsic contact area. Due to the fact that the side wall of the movable contact element usually is much smaller than the contact area itself, and therefore a possible welding between the moveable contact element and the fixed contact element is limited to a smaller area which causes a smaller cohesion.

In an embodiment of the invention, the geometric element above the moveable contact element in view of the opening direction having a geometric element with at least one member, which is able to impact the dynamics of the closing movement of the movable contact element is a geometry feature formed as tentacle. This tentacle works in connection with an opening in the movable contact element and is able to dive in this opening with friction.

Again the movable contact will be advantageously deferred in its closing movement due to the friction between said tentacle and the edge of the opening in the movable contact.

An embodiment of the invention relates to a geometric element above the moveable contact element in view of the opening direction having a geometric element with at least one member, which is able to impact the dynamics of the closing movement of the movable contact element by a geometric element, which is able to fix the movable contact element in the opening position.

Advantageously, it is possible that the movable contact element cannot close again without an additional action. If this action is done with an adequate delay, the contact material of the movable contact element and the fixed contact are re-frozen and cannot weld.

In an embodiment of the invention the geometric element above the moveable contact element in view of the opening direction having a geometric element with at least one member, which is able to impact the dynamics of the closing movement of the movable contact element by fixing the movable contact element in the opening position is a geometric element, which comprises a detent hook.

In a particular embodiment of the invention, the geometric element above the moveable contact element in view of the opening direction having a geometric element with at least one member, which is able to impact the dynamics of the closing movement of the movable contact element is located in the bridge contact working area.

According to a further aspect, and embodiment of the present invention provides a switching device comprising a buffer located in the bridge contact working area, which is able to remove the movable contact element from the fixed OUT position in the starting, i.e. ON, position.

In an embodiment of the invention the bridge contact working areal comprises a guide, which is in mesh with the movable contact element and which guides the movable contact element during its opening or closing movement in order to increase the reliability of the function of the switching device.

According to another embodiment, the present invention provides a method for lowering the risk of contact welding in a switching device after disconnecting of high currencies by the deferral of the closing movement of the movable contact element.

Advantageously an embodiment of the method uses the work done by the opening movement of the movable contact element to increase the work for the re-closing movement of the contact element.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments necessarily mutually exclusive of other embodiments.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain aspects commensurate in scope with the disclosed embodiments are set forth below.

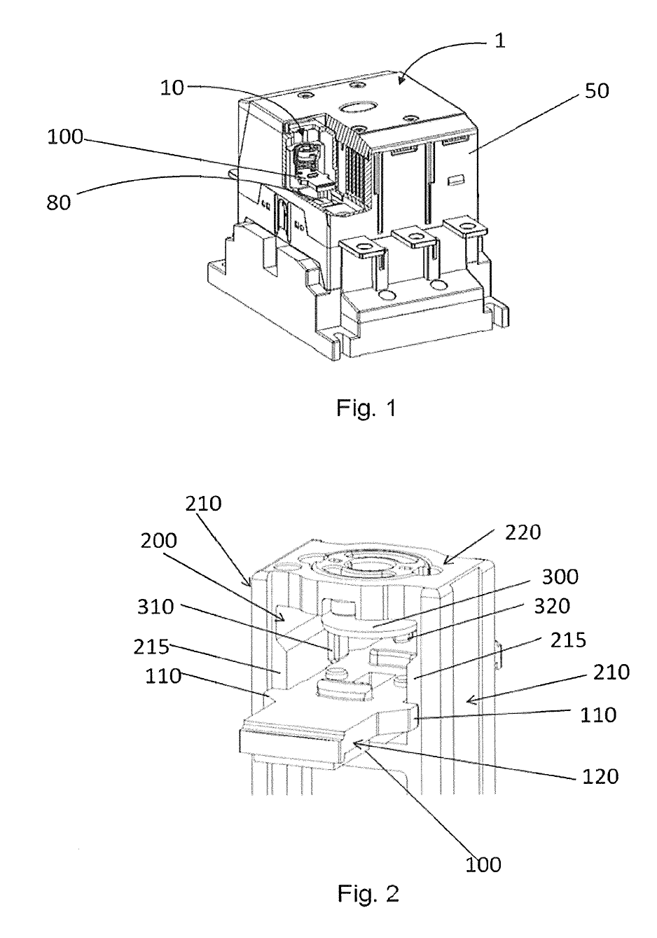

In FIG. 1 a switching device (1) comprising an actuator (10) in a housing (50) is shown. The switching device (1) comprises a fixed (80) and a movable contact element (100), which come in touch at their contact areas. This movable contact element (100) forms a contact bridge located in a bridge contact working area (200). The contact bridge (100) can be moved in the bridge contact working area (200) between a closed position, i.e. a position, where the fixed and the movable contact elements are in touch and which is called the ON position, and a open position, i.e. a position, where the fixed and the movable contact elements are not in touch and which is called the OFF position. The bridge contact working area (200) is formed by the fixed contact element (80), two side walls (210) and an upper side (220). This upper side (220) comprises elements with a geometry (300, 400, 500) with at least one member (310, 320, 410, 420, 510, 520), which is able to impact the dynamics of the closing movement of the movable contact element. The side walls (210) comprise guides (215), which are in mesh with guide elements (110) located at the movable contact element (100) and which guide the movable contact element during its opening or closing movement.

In a first embodiment shown in FIG. 2 the elements with a first geometry element (300), which is able to impact the dynamics of the closing movement of the movable contact element, in the upper side (220) of the bridge contact working area (200) contains a first, long member (310) and a second, in general by 180° offset short member (320). These members (310, 320) are located related in relation to the moveable contact element (100) in more or less the middle of the longitudinal dimension of said moveable contact element (100). Depending on the first geometry element (300) and/or the geometry of the guides (215, 110) at the side walls of the bridge contact working area (200) and at the moveable contact element (100), these members (310, 320) may also be located beyond the middle of the longitudinal dimension of the moveable contact element (100). In case the movable contact element (100) opens, i.e. moves from the fixed contact element (80) in direction of the upper side (220) of the bridge contact working area (200), it will come in contact with the first, long member (310). Due to this it will start to rotate by its longitudinal axis in parallel to the opening stroke. Thus the moveable contact element (100) transfers the translational opening work in rotation work. After the circuit is disconnected the moveable contact element (100) has to re-rotate in order to re-contact the fixed contact element (80), i.e. it has to expend again the rotational work, and therefore re-contact the fixed contact element (80) decelerated. As an additional effect possible electrode erosion and melting of the material of the moveable contact element (100) which is caused by the electric arc is located at the side wall (120) of the moveable contact element (100) located in general perpendicular to the contact area instead of at the intrinsic contact area. Due to the fact that the side wall (120) of the movable contact element (100) usually is much smaller than the contact area, and therefore a possible welding between the moveable contact element (100) and the fixed contact element (80) is limited to a smaller area which causes a smaller cohesion. Additionally this possibly melted area of the side wall of the movable contact element (120) cannot weld with the fixed contact, because it will not come in contact with the fixed contact due to its re-rotation movement. Thus the necessary force for breaking the welding is less than in the other case and may be achieved by the switching device.

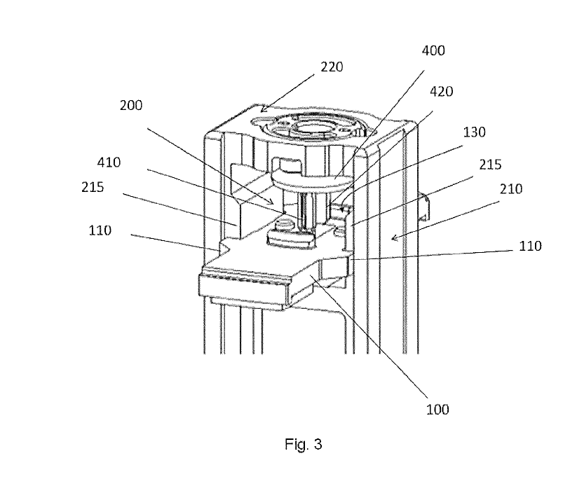

In a second embodiment shown in FIG. 3 the elements with a second geometry element (400), which is able to impact the dynamics of the closing movement of the movable contact element (100) in the upper side (220) of the bridge contact working area (200) contains members (410, 420) formed as tentacles, which act together with an opening (130) located in the movable contact element (100). The members (410, 420) fit in the opening (130) located in the movable contact element (100) with friction, thus the opening movement as well as the closing movement of the movable contact element (100) will be deferred. In case the surface of the contact elements (80, 100) was melted during the opening movement of the moveable contact element, it will be re-frozen until the contact elements (80, 100) will close again with deferral. In FIG. 3 one possibility of a geometric element (400) according to the invention is shown. It is understood that other geometric elements (400), able to dive in the opening (130) of the moveable contact element (100) with friction are possible as well.

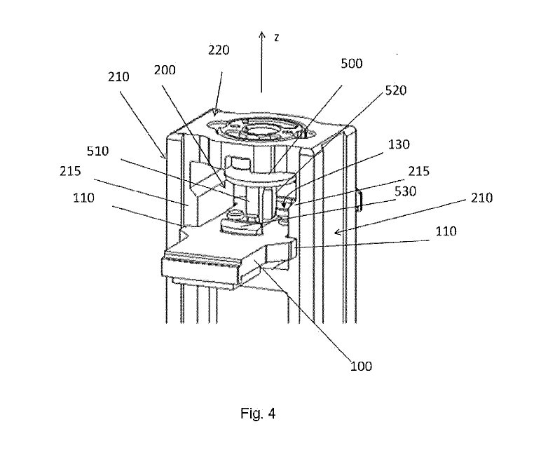

In a third embodiment shown in FIG. 4 the elements with a third geometric element (500), which is able to impact the dynamics of the closing movement of the movable contact element (100) in the upper side (220) of the bridge contact working area (200) contains elements formed as members (510, 520) containing detent hooks (530), which fit in the opening (130) located in the movable contact element (100). In case the movable contact element (100) opens completely, said members (510, 520) containing detent hooks (530) dip into the opening (130) located in the movable contact element (100). The members (510,520) containing detent hooks (530) are designed in such an extent that the hooks are able to snap in regarding recesses in the movable contact element (100) or dive completely through the movable contact element (100) in order to snap outside the opening (130). Thus the movable contact element (100) is fixed in the open position and cannot close again without any separate action for re-snapping. Such action may be carried out as follows: In the open position of the contacts the switching device can be turned in the position OFF. With that the whole construction inclusive the fixed moveable contact element (100) is moved in z direction. An additional buffer located in the bridge contact working area (200) pushes the moveable contact element out of the undercuts of the detent hooks (530). If the moveable contact element (100) is charged with a spring force, this force will move the moveable contact element back to the fixed contact element so that the contacts are closed again and the switching device reconnects the circuit.

In the drawings there are shown 2 members (410, 420) designed as tentacles or members (510, 520) with detent hooks (530). Of course it is also possible to fulfill the invention with only one regarding member (410, 420, 510, 520) or more than 2 members (410, 420, 510, 520).

The invention also relates to a method for lowering the risk of contact welding in such switching devices by using a device and dedicated process like described above.

### LIST OF REFERENCE NUMERALS

1 switching device
10 actuator
50 housing
80 fixed contact element
100 movable contact element
110 guide element
120 side wall of the movable contact element
130 opening
200 bridge contact working area
210 side wall
215 guide
220 upper side
300 first geometric element
310 long member
320 short member
400 second geometric element
410 first member of the second geometric element
420 second member of the second geometric element
500 third geometric element
510 first member of the third geometric element
520 second member of the third geometric element
530 detent hook

What is claimed is:

1. A switching device comprising:
a housing;
an actuator disposed in the housing and including a fixed contact element and a movable contact element, the movable contact element being a bridge forming contact in a bridge contact working area and being movable between a closed ON position and an open OFF position; and
a geometric component disposed above the movable contact element with respect to an opening direction of the movable contact element and including a geometric element configured to impact dynamics of a closing movement of the movable contact element.

2. The switching device recited in claim 1, wherein the geometric component is disposed in the bridge contact working area.

3. The switching device recited in claim 1, wherein the geometric element includes a elongated member configured to rotate the movable contact element by a longitudinal axis of the movable contact element as the movable contact element opens.

4. The switching device recited in claim 1, wherein the geometric element includes at least one tentacle member, and wherein the movable contact element includes an opening corresponding to the tentacle, the tentacle member being configured to dip in the opening with friction so as to slow down the closing movement of the movable contact element.

5. The switching device recited in claim 1, wherein the geometric element includes at least one fixing member configured to fix the movable contact element in response to an opening of the movable contact element.

6. The switching device recited in claim 5, wherein the at least one fixing member includes a detent hook configure to fit a corresponding opening disposed in the movable contact element.

7. The switching device recited in claim 6, wherein the detent hook is configured to catch a notch disposed in the corresponding opening of the movable contact element.

8. The switching device recited in claim 6, wherein the at least one fixing member is configured to dive through the corresponding opening of the movable contact element and catch outside the opening of the movable contact element.

9. The switching device recited in claim 5, further comprising a buffer disposed in the bridge contact working area and configured to remove the movable contact element from an OUT position in a starting ON position.

10. The switching device recited in claim 6, further comprising a buffer disposed in the bridge contact working area and configured to remove the movable contact element from an OUT position in a starting ON position.

11. The switching device recited in claim 1, wherein the bridge contact working area includes a guide meshing with the movable contact element and configured to guide the movable contact element during an opening movement and the closing movement of the movable contact element.

12. A method for reducing a risk of contact welding in a switching device, the method comprising:
providing a switching device including:
a housing,
an actuator disposed in the housing and including a fixed contact element and a movable contact element, the movable contact element being a bridge forming contact in a bridge contact working area and being movable between a closed ON position and an open OFF position, and
a geometric component disposed above the movable contact element with respect to an opening direction of the movable contact element and including a geometric element configured to impact dynamics of a closing movement of the movable contact element; and
impeding a closing movement of the movable contact element using the geometric element.

13. The method recited in claim 12, wherein the movable contact element is rotated by a longitudinal axis thereof in parallel to an opening and closing movement of the movable contact element.

14. The method recited in claim 12, wherein a velocity of the closing movement of the movable contact element is reduced through friction of mechanical elements of the switching device.

15. The method recited in claim 12, further comprising fixing the movable contact element in an opening position.

16. The method recited in claim 15, wherein the movable contact element is moved against a buffer disposed above the movable contact element with respect to the opening direction of the movable contact element so as to release the movable contact element from the open position.
